(19) United States
(12) Patent Application Publication
(10) Pub. No.: US 2013/0313087 A1
(43) Pub. Date: Nov. 28, 2013

(54) WATERTIGHT BUTTON AND ELECTRONIC DEVICE HAVING THE SAME

(71) Applicants: HONG FU JIN PRECISION INDUSTRY (SHENZHEN) CO., LT, Shenzhen (CN); HON HAI PRECISION INDUSTRY CO., LTD., New Taipei (TW)

(72) Inventor: FU-FA LE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/688,246

(22) Filed: Nov. 29, 2012

(30) Foreign Application Priority Data
May 28, 2012 (CN) 201210168282.7

(51) Int. Cl. H01H 13/06

(52) U.S. Cl. CPC H01H 13/06
USPC 200/302.2

(57) ABSTRACT

A watertight button and an electronic device are disclosure. The watertight button includes a button cap, a push element, a deformable and recoverable element, and a waterproof ring. The waterproof ring is made of elastic material, a portion of the shaft body between the head and the flange is extended through the through hole of the deformable and recoverable element. The head of the push element is received in a recess of the button cap. The deformable and recoverable element is configured to be deformed to enable the push element to be depressed when an external force is applied on the button cap, and to move the push element back to an original position upon the external force being removed. The watertight button is simple and generates a good anti-dust and waterproof protection.

### BACKGROUND

1. Technical Field

The disclosure relates to buttons and, more particularly, to a watertight button and an electronic device having such watertight button.

2. Description of Related Art

Electronic devices, such as mobile phones, have some keys. Simple keys have poor anti-dust and waterproof protection. Although there exists some complicated keys having a good anti-dust and waterproof effect, the cost of the complicated keys is high.

Therefore, what is needed is a watertight button to overcome the described shortcoming.

### BRIEF DESCRIPTION OF THE DRAWINGS

FIG. 1 is a perspective view of an electronic device in accordance with an exemplary embodiment.

FIG. 2 is an exploded, perspective view of a watertight button of the electronic device of FIG. 1 in accordance with a first exemplary embodiment.

FIG. 3 is an exploded, perspective view of a watertight button of the electronic device of FIG. 1 in accordance with a second exemplary embodiment.

FIG. 4 is an enlarged view of a push element of the watertight button of FIG. 2.

FIG. 5 is a perspective view of the watertight button of FIG. 2.

FIG. 6 is a cross-sectional view taken along line IV-IV of the electronic device of FIG. 1

### DETAILED DESCRIPTION

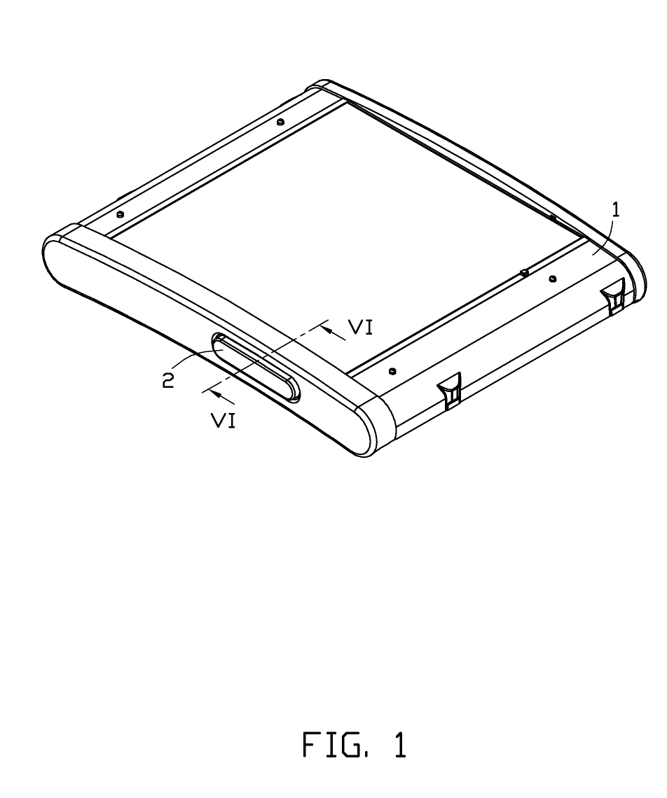

FIG. 1 is a perspective view of an electronic device in accordance with an exemplary embodiment. The electronic device 1 includes a housing 11, a watertight button 2, and a push button circuit (not shown). The watertight button 2 is positioned in the housing 11 of the electronic device 1 and extends from the housing 11. The electronic device 1 may be a mobile phone, a notebook, and a watch, for example. For illustration purposes, a watch is used as an example.

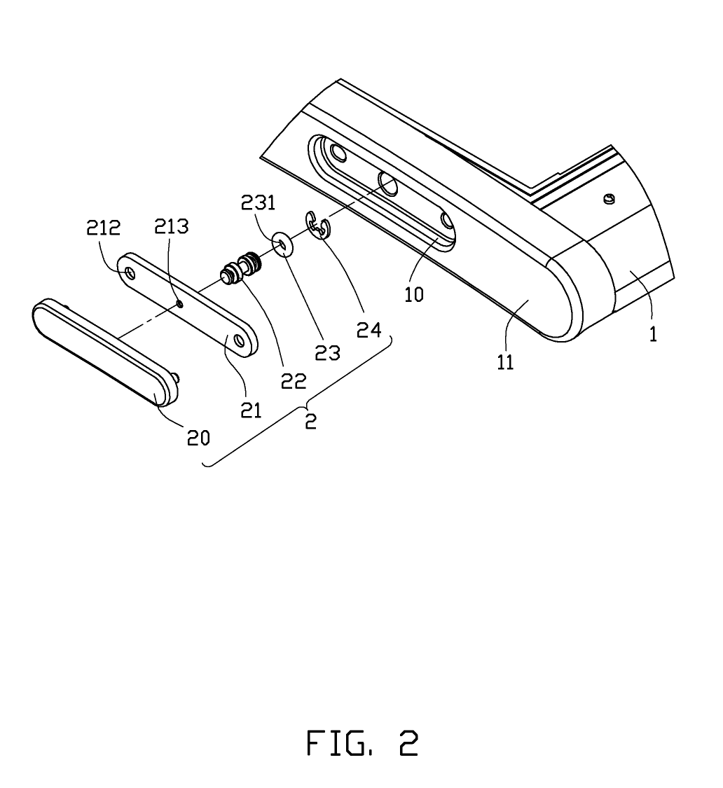

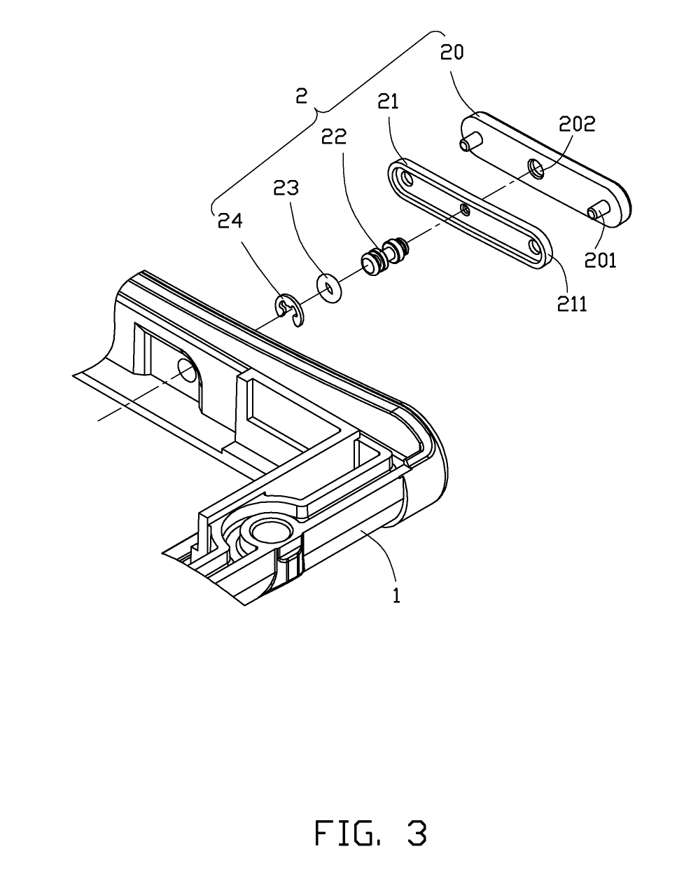

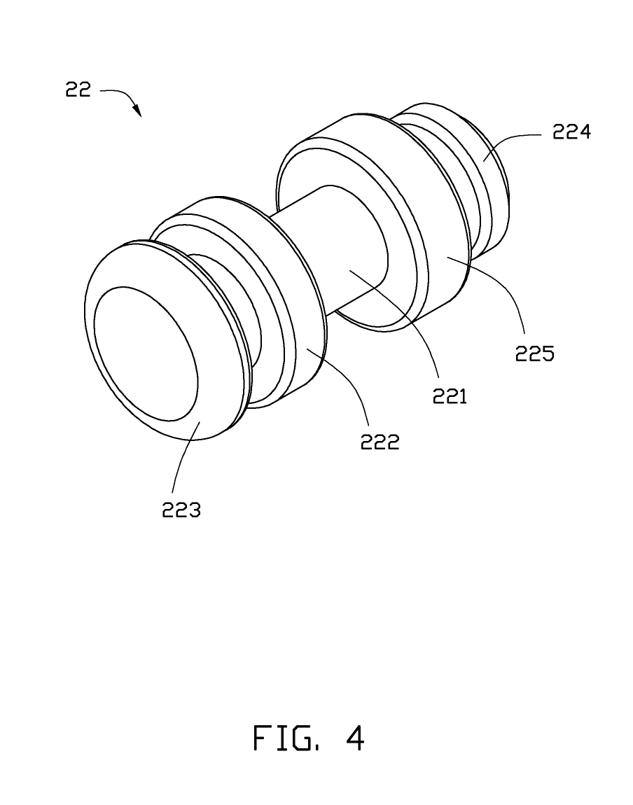

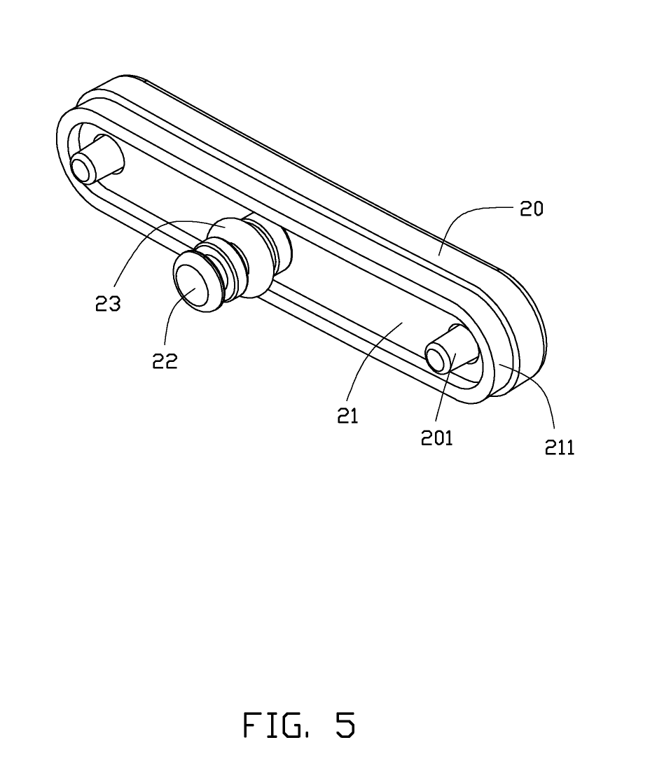

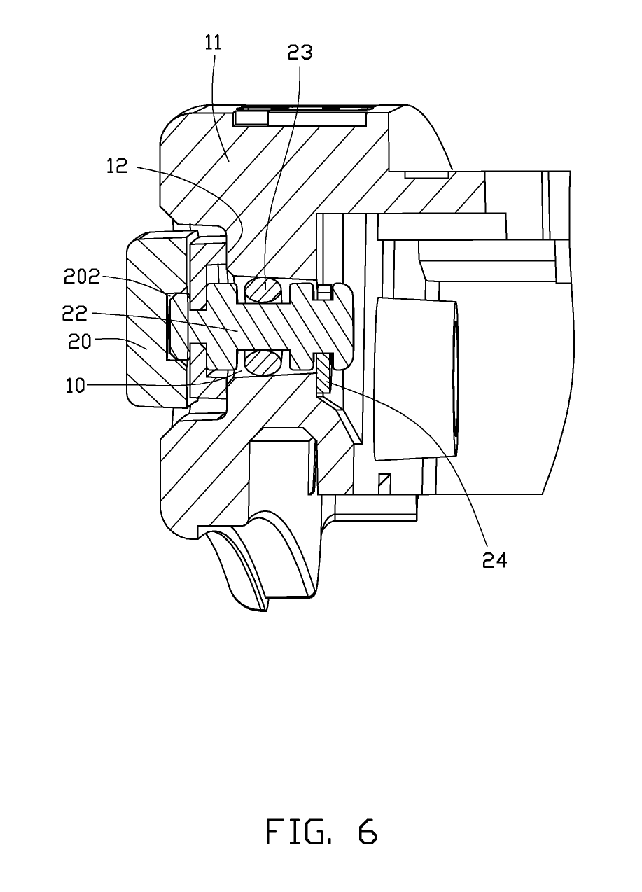

FIGS. 2-6 show that the watertight button 2 includes a button cap 20, a deformable and recoverable element 21, a push element 22, and a deformable waterproof ring 23. The button cap 20 extends from the watch 1, and when the button cap 20 is pressed in response to user inputs, the button cap 20 moves. Two ends of a body of the button cap 20 respectively extend from a protrusion part 201 in vertical direction. A recess 202 is formed in the middle of the body of the button cap 20. The button cap 20 is made of plastic material.

The deformable and recoverable element 21 is similar to the button cap 20 and attached to the button cap 20. A body of the deformable and recoverable element 21 is a plane board. A sidewall 211 extends from the circumferential surface of the body of the deformable and recoverable element 21 in vertical direction. A first through hole 212 is formed at each end of the body of the deformable and recoverable element 21 and a second through hole 213 is formed in the middle of the deformable and recoverable element 21. The deformable and recoverable element 21 is made of elastic material, such as rubber. When an external force is applied on the deformable and recoverable element 21, the deformable and recoverable element 21 deforms, and when the external force disappears, the deformable and recoverable element 21 reforms.

A body of the push element 22 is a shaft 221. Two flanges 222, 225 are formed on the circumferential surface of the shaft 221 and space from each other. Two heads 223, 224 are formed at two distal ends of the shaft 221. The push element 22 is made of rigid material, such as metal. A distance between the flange 222 and the head 223 is equal to the thickness of the body of the deformable and recoverable element 21; thereby the deformable and recoverable element 21 is attached to the flange 222 and the head 223.

The waterproof ring 23 is positioned between the two flanges 222, 225 and wrapped around the shaft 221. A circle through hole 231 is formed in the middle of the waterproof ring 23. A diameter of the circle through hole 231 is equal to a diameter of a bottom surface of the shaft 221 of the push element 22, thereby the waterproof ring 23 is engaged with the circumferential surface of the shaft 221 between the two flanges 222, 225. The waterproof ring 23 is made of elastic material, such as rubber. For preventing the waterproof ring 23 from breaking away the push element 22, the two flanges 222, 225 are utilized to restrict the position of the waterproof ring 23. In another embodiment, only the flange 222 restricts the position of the waterproof ring 23.

Because the deformable and recoverable element 21 is soft, the second through hole 213 can be stretched to become greater, the head 223 passes through the second through hole 213, and the deformable and recoverable element 21 is engaged between the head 223 and the flange 222. When the deformable and recoverable element 21 reforms, the shaft 221 is engaged with the second through hole 213. The two protrusion parts 201 respectively pass through and are engaged with the two first through holes 212. The body of the deformable and recoverable element 21 is attached to the body of the button cap 20. Furthermore, gum water is stuck between the deformable and recoverable element 21 and the button cap 20.

The head 223 is positioned on the recess 202 and withstands the button cap 20 after passing through the second through hole 213. Because the waterproof ring 23 is soft, the circle through hole 231 can be stretched to become larger. The head 224 and the flange 225 pass through the circle through hole 231, and the waterproof ring 23 is engaged between the two flanges 222, 225 and can move between the two flanges 222, 225. The waterproof ring 23 can reform and adhere to the circumferential surface of the shaft 221.

The watertight button 2 further includes a clip element 24. The clip element 24 is engaged with the circumferential surface of the shaft 221. The clip element 24 is positioned between the head 224 and the flange 225 and utilized to install the watertight button 2 on the housing 11 of the electronic device 1.

The housing 11 defines a button receiving hole 10 for accommodating the watertight button 2 and has an inner surface 13 in the button receiving hole 10. The push button circuit has a contact portion exposed at a lower portion of the button receiving hole 10. The contact portion is configured to be activated. When the watertight button 2 is installed on the electronic device 1, a portion of the shaft 221 between the head 224 and the flange 225 is extended through the second through hole 213 of the deformable and recoverable element 21, the housing 11 of the electronic device extrudes two points of the waterproof ring 23 and the waterproof ring 23 deforms and is attached to the inner surface 13 of the housing 11 and the shaft 221, thereby both dust and water is resisted from entering the electronic device 1. The sidewall 211 of the deformable and recoverable element 21 is attached to two end faces 12 of the housing 11.

When an external force is applied on the button cap 20, the push element 22 moves, the sidewall 211 of the deformable and recoverable element 21 is extruded and adhered on two end faces 12 of the housing 11, and the deformable and recoverable element 21 is deformed to enable the push element 22 to be depressed to contact and activate the contact portion, thereby establishing an electric connection of the electronic device 1 via the watertight button 2. The waterproof ring 23 is positioned between the housing 11 and the flanges 222, 225 all the time, thereby generating good protection against dust and is waterproof. When the external force is removed, the deformable and recoverable element 21 reforms to move the push element 22 away from the contact portion and back to an original position and the button cap 20 restores to an original position, thereby disconnecting the electronic device 1 and the watertight button 2.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A watertight button comprising:
a button cap having a recess defined therein;
a push element having a shaft body, a head formed at a distal end of the shaft body; and a flange formed on the circumferential surface of the shaft body adjacent to the head;
a deformable and recoverable element attached to the button cap, the deformable and recoverable element defining a through hole; and
a deformable waterproof ring wrapped around the shaft body;
wherein the waterproof ring is made of elastic material, a portion of the shaft body between the head and the flange extending through the through hole of the deformable and recoverable element, the head received in the recess of the button cap, the deformable and recoverable element being configured to be deformed to enable the push element to be depressed when an external force is applied on the button cap, and to move the push element back to an original position upon the external force being removed.

2. The watertight button as recited in claim 1, wherein the push element is made of rigid material.

3. The watertight button as recited in claim 1, further comprising a clip element engaged with another distal end of the shaft body.

4. The watertight button as recited in claim 1, wherein the waterproof ring is configured for being in waterproof engagement between the shaft body and an inner surface of a button receiving hole of an electronic device.

5. The watertight button as recited in claim 1, further comprising another flange formed on the circumferential surface of the shaft body, wherein the waterproof ring is arranged between the two flanges.

6. An electronic device comprising:
a housing defining a button receiving hole, the housing having an inner surface in the button receiving hole;
a push button circuit having a contact portion exposed at a lower portion of the button receiving hole, the contact portion configured to be activated;
a button cap having a recess defined therein;
a push element having a shaft body, a head formed at a distal end of the shaft body; and a flange formed on the circumferential surface of the shaft body adjacent to the head;
a deformable and recoverable element attached to the button cap, the deformable and recoverable element defining a through hole; and
a deformable waterproof ring wrapped around the shaft body;
wherein the waterproof ring is made of elastic material, a portion of the shaft body between the head and the flange extending through the through hole of the deformable and recoverable element, the head received in the recess of the button cap, the deformable and recoverable element being configured to be deformed to enable the push element to be depressed to contact and activate the contact portion when an external force is applied on the button cap, and to move the push element away from the contact portion and back to an original position upon the external force being removed.

7. The electronic device as recited in claim 6, wherein the push element is made of rigid material.

8. The electronic device as recited in claim 6, further comprising a clip element engaged with another distal end of the shaft body.

9. The electronic device as recited in claim 6, wherein the waterproof ring is configured for being in waterproof engagement between the shaft body and the inner surface of the button receiving hole.

10. The electronic device as recited in claim 6, further comprising another flange formed on the circumferential surface of the shaft body, wherein the waterproof ring is arranged between the two flanges.
